(19) United States
(12) Patent Application Publication
(10) Pub. No.: US 2026/0009887 A1
(43) Pub. Date: Jan. 8, 2026

(54) FIBER-BASED SPATIAL FILTER

(71) Applicant: L3Harris Technologies, Inc., Melbourne, FL (US)

(72) Inventor: Edward MIESAK, Windermere, FL (US)

(21) Appl. No.: 18/763,027

(22) Filed: Jul. 3, 2024

(51) Int. Cl. G01S 7/481

(52) U.S. Cl. CPC G01S 7/4816; G01S 7/4818

(57) ABSTRACT

An optical receiver comprises an optical detector, including a detection surface having a linear dimension, and a spatial filter. The spatial filter comprises a detector lens and an optical fiber. The detector lens focuses an optical signal at a focal point located at a focal length from the detector lens. A field of view of the optical detector is a function of the linear dimension of the detection surface and the focal length of the detector lens. The optical fiber has a first end mounted at the focal point of the detector lens to receive the optical signal, and a second end coupled to the optical detector. The optical fiber propagates only light received at incident angles no greater than an acceptance angle, which is sized relative to the field of view of the optical detector to spatially filter incident light outside the field of view of the optical detector.

### TECHNICAL FIELD

The present disclosure relates to a fiber-based spatial filter for an optical system.

### BACKGROUND

Laser systems that transmit and receive laser signals are used in a variety of applications. In the context of range finding and imaging, a laser system may be required both to transmit laser signals and to receive return laser signals that are reflected from objects in the system's field of view (FOV). One example is an Eye-safe Laser Range Finder (LRF), which should have a compact, rugged, and reliable design and and should meet minimum performance requirements. Such systems typically are required to determine the range of objects in the FOV down to a minimum range requirement. A known design approach is to use a coaxial system in which one telescope is used to launch the laser beam and to collect the return signal. This design simplifies the system and reduces volume and cost.

Internal light scattering from several sources in an LRF can saturate the detector that detects the arrival of return laser signals. One dominant source of such internal light scattering can be light from out-going laser pulses. For a reflected laser signal to be detectable by the detector, the transmitting LRF laser must emit high-energy outgoing laser pulses to generate sufficient photon scattering off the target. These out-going laser pulses also saturate the detector as they pass through and reflect off the LRF optics on their way out of the housing. More specifically, each laser pulse sent through the optical transmit train in the system may scatter off the surfaces and internal bulk of each optical element. Though each scattering site may be small, the accumulation of many scattering sites can be sufficient to saturate the detector on every laser transmit shot. The system housing itself provides additional surfaces off of which such light may scatter, thus homogenizing the scattered light inside the housing.

The duration the detector remains saturated by internal light scattering and unable to detect returning laser signals is dependent on the amount (intensity) of the internal light to which the detector is exposed. If, upon transmission of a laser pulse, the period the detector remains in saturation exceeds the shortest expected round-trip delay time of the laser pulse (i.e., resulting from reflection off of closer objects in the field of view), the minimum range requirements of the LRF may not be met and short-range objects cannot be detected.

A prime concern of LRF design, consequently, is to minimize detector saturation due to the out-going laser pulses. LRFs deal with internal light scattering by judicious optical design, including minimizing optical scatter and applying optically absorbent coatings everywhere inside the LRF that comes into contact with scattered light. A spatial filter positioned in front of the optical detector of an LRF can significantly reduce the amount of internal light scattering that reaches the optical detector, thereby addressing the detector saturation problem. Conventional spatial filter designs, however, require multiple optical elements, a pinhole structure, and linear translational “X-Y-Z” mechanical stages to position and hold the components in place during shock, vibration, and temperature excursions. Such optical elements and mechanical stages are difficult to set up and maintain in precise alignment and require considerable space. A simpler approach to spatial filtering that does not sacrifice performance would be desirable.

### BRIEF DESCRIPTION OF THE DRAWINGS

FIG. 1 is a high-level block diagram of a coaxial laser range finder (LRF) having an optical receiver without a spatial filter to reduce the amount of internal light scattering that reaches the optical detector.

FIG. 2 shows the presence of internal light scattering in the vicinity of the optical detector in the optical receiver design of FIG. 1.

FIG. 3 is a high-level block diagram of a coaxial LRF with a spatial filter positioned in front of the optical detector to reduce the amount of internal light scattering that reaches the optical detector.

FIG. 4 is an expanded view of the spatial filter in the optical receiver of FIG. 3.

FIG. 5 shows the operation of the spatial filter of FIGS. 3 and 4 in reducing the amount of internal light scattering reaching the optical detector.

FIG. 6 is a cut-away view showing the layers of an optical fiber.

FIG. 7 is a diagram illustrating the principle of an acceptance angle for the core of an optical fiber and the propagation path of light through the optical fiber.

FIG. 8 is a diagram that explains the principle of total internal reflection in relation to the critical angle at the boundary between the core and cladding of an optical fiber.

FIG. 9 is a high-level block diagram of an LRF having an optical receiver with a spatial filter implemented with an optical fiber.

FIGS. 10A-10C respectively show circular, square, and rectangular detection surfaces for the detector element, illustrating linear dimensions of the detector element.

FIG. 11 is an expanded view of a portion of FIG. 9 showing the optical fiber mount located at the focal point of the detector lens.

### DESCRIPTION

### Overview

According to a disclosed embodiment, an optical receiver comprises an optical detector, including a detection surface having a linear dimension, and a spatial filter. The spatial filter comprises a detector lens and an optical fiber. The detector lens focuses a collimated optical signal at a focal point located at a focal length from the detector lens. A field of view of the optical detector is a function of the linear dimension of the detection surface of the optical detector and the focal length of the detector lens. The optical fiber has a first end mounted at the focal point of the detector lens to receive the optical signal, and a second end coupled to the optical detector. The optical fiber propagates only light received at incident angles no greater than an acceptance angle. The acceptance angle of the optical fiber is sized relative to the field of view of the optical detector to spatially filter incident light outside the field of view.

### Example Embodiments

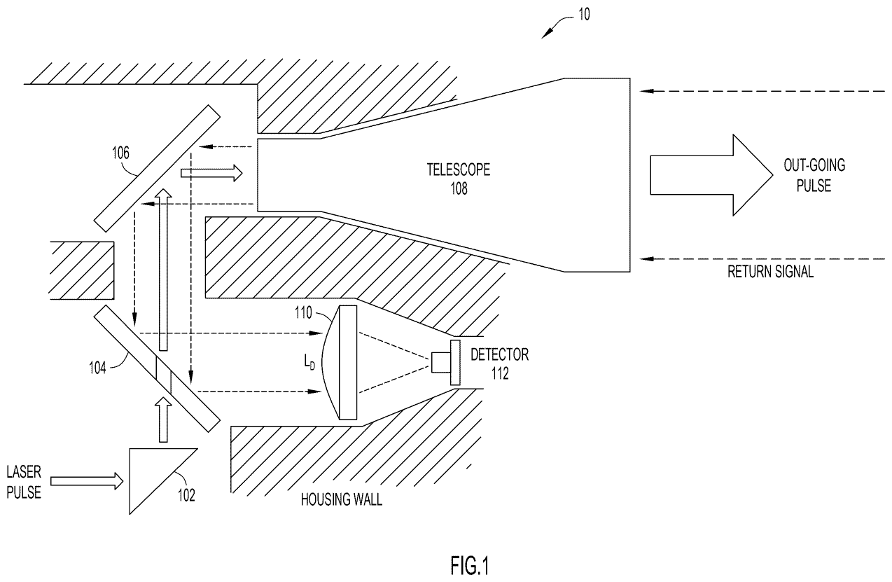

FIG. 1 is a high-level diagram of a coaxial laser range finder (LRF) 10 in which one telescope is used to launch the laser beam and to collect the return signal. An outgoing laser pulse generated by a laser source enters a prism 102, which changes the direction of the laser pulse by 90°. In the orientation shown in FIG. 1, the laser pulse initially traveling horizontally from left to right is redirected by prism 102 to travel vertically upward. The redirected laser pulse passes through a central aperture in a first “donut” mirror 104 and reflects off a second mirror 106 oriented at 45° relative to the incident direction of the redirected laser pulse, thereby changing the direction of the laser pulse by 90°. In the example of FIG. 1, the laser pulse traveling vertically upward is reflected off second mirror 106 in a horizontal direction, thereby traveling left to right. The laser pulse reflected off second mirror 106 enters an up-collimating telescope 108 which directs the out-going laser pulse to its intended target. When the out-going laser pulse impinges on an object in the field of view, it generates a reflected return signal, shown with dashed lines, that travels back to telescope 108 where it is captured and down-collimated. The return signal exits telescope 108 (traveling right to left in the example shown in FIG. 1) and reflects off second mirror 106 at 90° from the incident direction, traveling vertically downward in the example of FIG. 1. First mirror 104 is oriented at 45° relative the vertical direction of travel of the reflected return signal and reflects the return signal 90° such that the twice-reflected return signal travels in the horizontal direction towards a detector lens 110 that focuses the return signal on an optical detector 112.

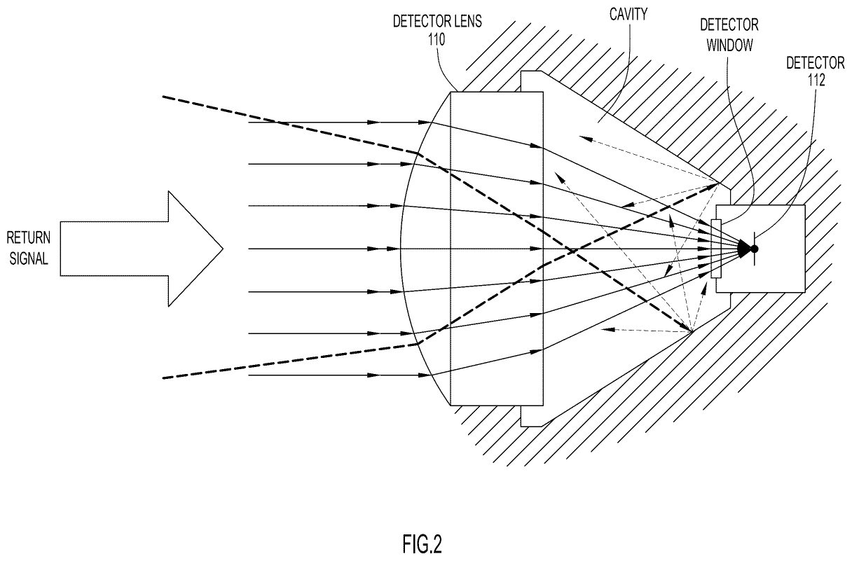

The optical receiver design shown in FIG. 1 is susceptible to scattered light, as shown in the diagram in FIG. 2. All the light that reaches detector lens 110, whether scattered from the outgoing laser pulse or from the return laser signal, ends up in the cavity in front of the optical detector 112. Light that is not parallel with the return signal rays will hit something in the cavity other than the optical detector 112. Light hitting the cavity walls will scatter multiple times until it is absorbed. During this time, the cavity will be filled with light. Optical detector 112 responds to this light as well as any legitimate return signal that may be present. Typically, scattered light, particularly from an outgoing laser pulse, makes a stronger signal on the optical detector 112 than any return signal light.

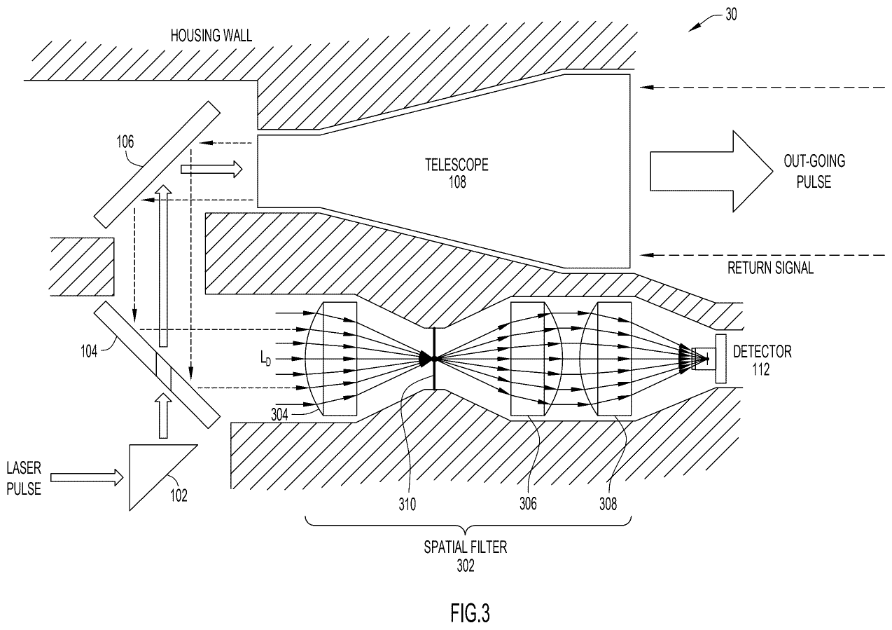

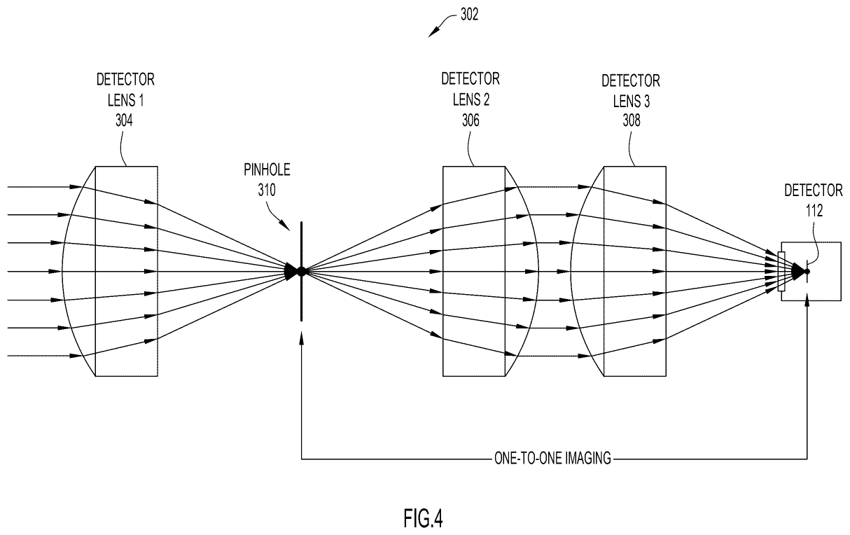

A spatial filter discriminates against light ray angles and is designed to transmit near-parallel rays coming from a specific direction. FIG. 3 shows an LRF 30 having a comparable architecture to LRF 10 shown in FIG. 1 but with a multi-lens spatial filter 302 positioned in front of the optical detector 112. FIG. 4 is an expanded view of spatial filter 302 shown in FIG. 3. The spatial filter 302 includes a first detector lens 304, a second detector lens 306, a third detector lens 308, and a pinhole 310. The three detector lenses are used to preserve the FOV that would result in the absence of the spatial filter. The return signal rays are nearly parallel, i.e., collimated. The incident return signal light is focused by first detector lens 304 and passes through pinhole 310 (i.e., the pinhole is located substantially at the focal point of first detector lens 304). Second detector lens 306 re-collimates the light downstream of pinhole 310, and third detector lens 308 focuses this light onto the optical detector 112. One-to-one imaging creates the same spot size and cone of light on the detector that is present at the pinhole 310, which is consistent with the optical detector 112 being at the location of the pinhole 310 in the absence of the spatial filter 302.

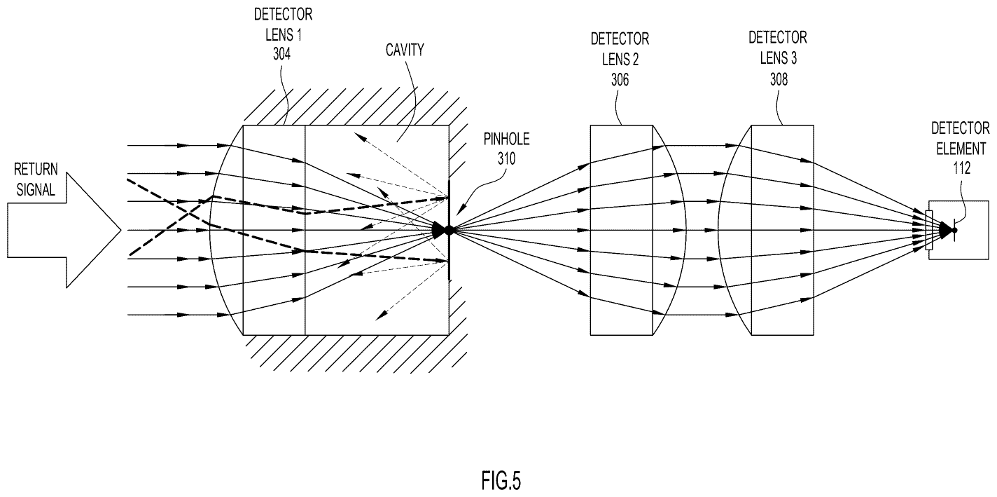

Scattered light contains a wide variety of ray angles. The return signal is nearly collimated and has a very small variety of ray angles. Any rays not parallel or nearly parallel with the axis of a spatial filter will not pass the pinhole, but the return signal will easily pass through the pinhole. FIG. 5 illustrates the reflection of light at the pinhole 310 that passes through first detector lens 304 but is not parallel or nearly parallel with the axis of the spatial filter 302. All the light reaching first detector lens 304 ends up in the cavity in front of pinhole 310, but only rays parallel or nearly parallel with the return signal will pass through pinhole 310 and illuminate the optical detector 112. This arrangement greatly reduces scattered light reaching the detector in the LRF 30.

While the spatial filter arrangement shown in FIGS. 3-5 is capable of reducing the amount of internal light scattering that reaches the detector, inclusion of this spatial filter significantly increases the space required within the LRF housing to accommodate the receiver optics and requires careful setup and maintenance of X-Y-Z mechanical stages to stabilize the optical components. An alternative approach to implementing spatial filtering involves employing an optical fiber in the receiver optics. An optical fiber is a flexible, transparent fiber typically made by drawing glass, quartz, or plastic to a diameter about as thick as a human hair.

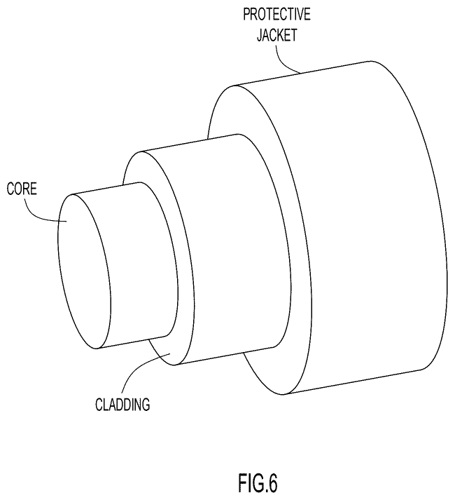

Optical fibers are used most often to transmit light between the two ends of the fiber. As shown in FIG. 6, an optical fiber typically includes a core surrounded by a transparent cladding material with a lower index of refraction than the core. The cladding is encased in an outer protective jacket. Light is kept in the core by the phenomenon of total internal reflection, which causes the fiber to act as a waveguide. Fibers that support many propagation paths or transverse modes are called multimode fibers, while those that support a single mode are called single-mode fibers. An optical fiber will propagate light that enters the fiber only at angles less than a maximum angle known as the acceptance cone of the fiber. The half-angle of this cone is called the acceptance angle, θ_{Acc}. That is, the maximum angle that light can enter the fiber and be captured by the core so that it propagates along the length of the fiber is θ_{Acc}, the acceptance angle of the optical fiber. The optical receiver and spatial filter described herein can be implemented with either a multimode fiber or a single-mode fiber. Multimode fibers are more susceptible to temporal dispersion, making them more suitable for shorter distance applications of up to a few kilometers, whereas single-mode fibers are better suited for longer distance applications. Both single-mode and multimode fibers are suitable for the fiber lengths required for the described optical receiver, though a single-mode fiber typically has a narrower acceptance angle than a comparable multimode fiber.

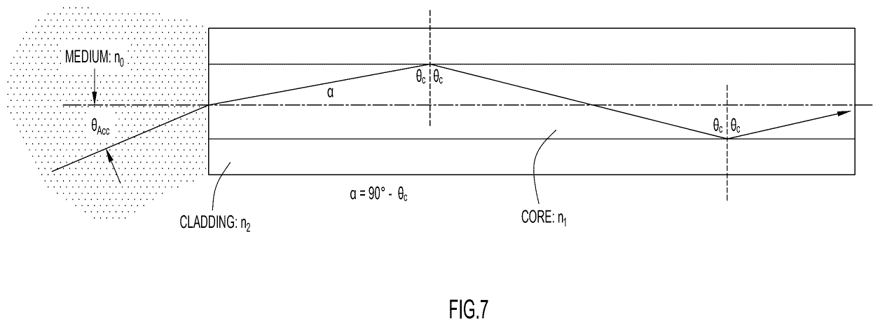

FIG. 7 illustrates the acceptance angle θ_{Acc} for an example optical fiber with a core comprising a medium having an index of refraction n₁ surrounded by a cladding comprising a medium having an index of refraction n₂. Light propagating in an ambient medium (e.g., air or a vacuum) with an index of refraction n₀ enters the core of the optical fiber. If the light entering the core is received at an angle no greater than the acceptance angle θ_{Acc}, the light will reflect off of the core-cladding interface and continue to propagate through the core of the optical fiber as a result of total internal reflection (TIR). TIR is an optical phenomenon in which waves traveling in a first medium and arriving at the boundary between the first medium and a second medium having a different index of refraction are not refracted into the second medium but instead are completely reflected back into the first medium. This phenomenon occurs when the second medium has a higher wave speed or lower refractive index than the first medium and the waves are incident at a sufficiently oblique angle on the interface. The angle defining this phenomenon is the critical angle θ_{c}, which is the smallest angle of incidence that yields total reflection, the angle of incidence being the angle between the direction of the incident light and a plane normal to the longitudinal direction of the optical fiber, (i.e., perpendicular to the boundary of the core and the cladding, as shown in FIG. 7). Owing to the core's index of refraction n₁ relative to the index of refraction n₀ of the ambient medium, the acceptance angle θ_{Acc} entering the core of the optical fiber corresponds to a maximum propagation angle α within the core, relative to the longitudinal axis of the optical fiber. The maximum propagation angle α is related to the critical angle θ_{c} by:

$$α = 90 ° - {θ}_{C} \qquad ( 1 )$$

The critical angle is given by:

$${θ}_{C} = {sin}^{- 1} \frac{{n}_{2}}{{n}_{1}} \qquad ( 2 )$$

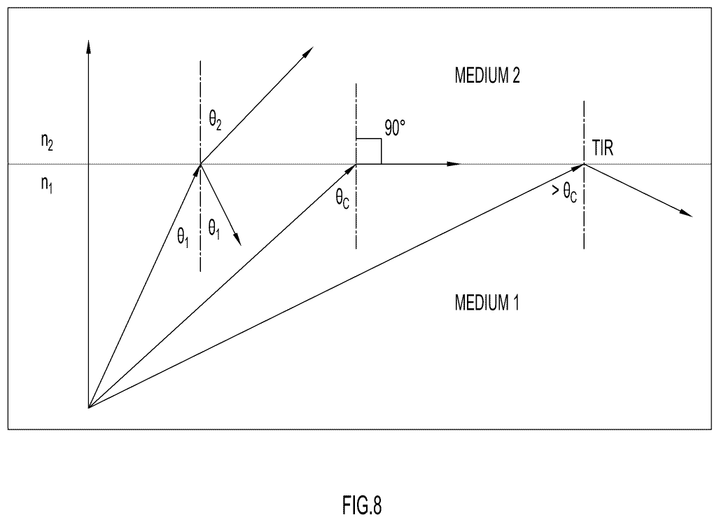

FIG. 8 shows a series of light waves with increasing angles of incidence upon an interface between two media. The index of refraction of medium₁, n₁, is greater than the index of refraction of medium₂, n₂. When the angle of incidence is less than the critical angle θ_{c}, a portion of the wave passes through the interface and a portion of it reflects off the interface, as shown by angles θ₁ and θ₂. When the angle of incidence equals θ_{c} the incident wave does not reflect off the interface or transmit through the interface; it propagates along the interface. This is the definition of the critical angle θ_{c}. If the angle of incidence is larger than the critical angle θ_{c}, the incident wave will reflect off the interface with nearly zero loss. This condition is used by optical fibers to confine the light wave in its core. This light wave will experience very low loss as it propagates along the length of the fiber.

The maximum angle of acceptance for an optical fiber, i.e., the maximum angle of incidence for a ray of light to enter a fiber and remain confined to the core is given by:

$${θ}_{Acc} = {sin}^{- 1} ( \frac{1}{{n}_{0}} \sqrt{{n}_{Core}^{2} - {n}_{Cladding}^{2}} ) , {n}_{core} > {n}_{Cladding} \qquad ( 3 )$$

As previously described, the front end of a spatial filter is typically constructed by using a lens to focus light through a pinhole. Light can be coupled into an optical fiber in a similar similar manner using a lens to focus light into the core of the fiber. A spatial filter uses additional optics to collect the light passing through the pinhole and deliver it to the detector element, as shown in FIG. 4. An optical fiber can be directly coupled to a detector element, eliminating the need for such additional optics.

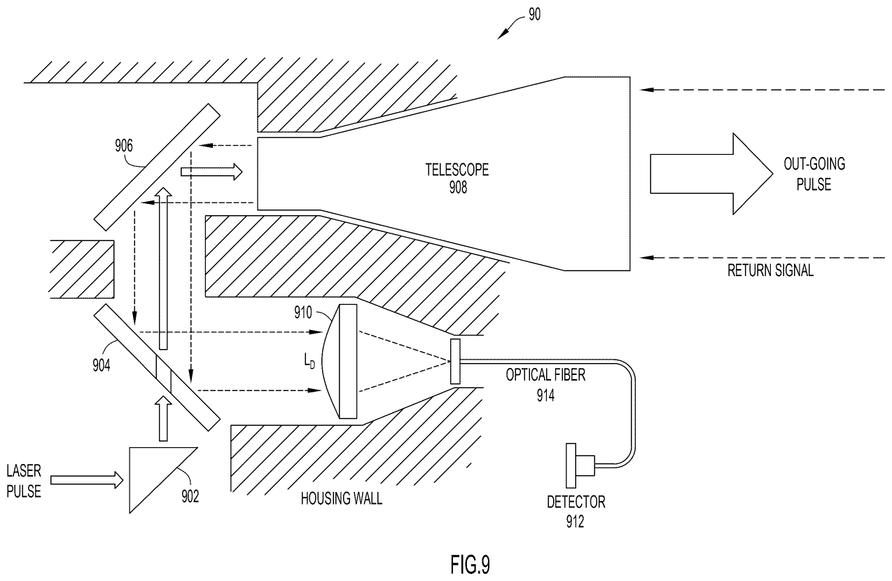

FIG. 9 illustrates an LRF system 90 in which a fiber-based spatial filter employs an optical fiber to transmit only near-parallel rays coming from a specific direction while discriminating against (filtering out) light rays from other angles. An outgoing laser pulse generated by a laser source enters a prism 902, which changes the direction of the laser pulse by 90°. In the orientation shown in FIG. 9, the laser pulse initially traveling horizontally from left to right is redirected by prism 902 to travel vertically upward. The redirected laser pulse passes through a central aperture in a first mirror 904 and reflects off a second mirror 906 oriented at 45° relative to the incident direction of the redirected laser pulse, thereby changing the direction of the laser pulse by 90°. In the example of FIG. 9, the laser pulse traveling vertically upward is reflected off second mirror 906 in a horizontal direction, thereby traveling left to right after reflection. The laser pulse reflected off second mirror 906 enters an up-collimating telescope 908 which directs the out-going laser pulse to its intended target.

When the out-going laser pulse strikes an object in the field of view, the laser pulse is at least partially reflected from the object and generates a return signal, shown with dashed lines, that travels back to telescope 908 where it is captured and down-collimated. The return signal exits telescope 908 (traveling right to left in the example shown in FIG. 9) and reflects off second mirror 906 at 90° from the incident direction, traveling vertically downward in the example of FIG. 9. First mirror 904 is oriented at 45° relative the vertical direction of travel of the reflected return signal and reflects the return signal 90° such that the twice-reflected return signal travels in the horizontal direction towards a detector lens 910, which focuses the collimated return signal at a focal point located at a focal length from the detector lens 910. According to a non-limiting example, the focal length of detector lens can be on the order of a few millimeters, e.g., 5-8 mm. According to one implementation, detector lens 910 can have one flat and one curved surface, i.e., planoconvex lens. A planoconvex lens typically produces the lowest optical distortion when its flat surface faces its focal point, as shown in FIG. 9. While the example shown in FIG. 9 represents the detector lens 910 as a single lens, it will be appreciated that the “detector lens” can be constituted by one lens or a plurality of lenses operating together to focus the return signal at a focal point.

An optical fiber 914 has a first end mounted at the focal point of the detector lens 910 to receive the focused return signal. The second end of optical fiber 914 is coupled to an optical detector 912. As explained herein in detail, the optical fiber propagates only light received at incident angles no greater than the acceptance angle, which is sized relative to the receiver field of view to spatially filter incident light outside the field of view, such that the detector lens 910 and optical fiber 914 together implement a spatial filter. The length of optical fiber 914 can be optimized using two criteria: discrimination against unwanted propagation modes, and retention of the leading edge of the optical pulse of the return signal. The optical components in the receive path of the return signal, including in this example, telescope 908, mirrors 904 and 906, detector lens 910, optical fiber 914, and optical detector 912, together constitute an optical receiver.

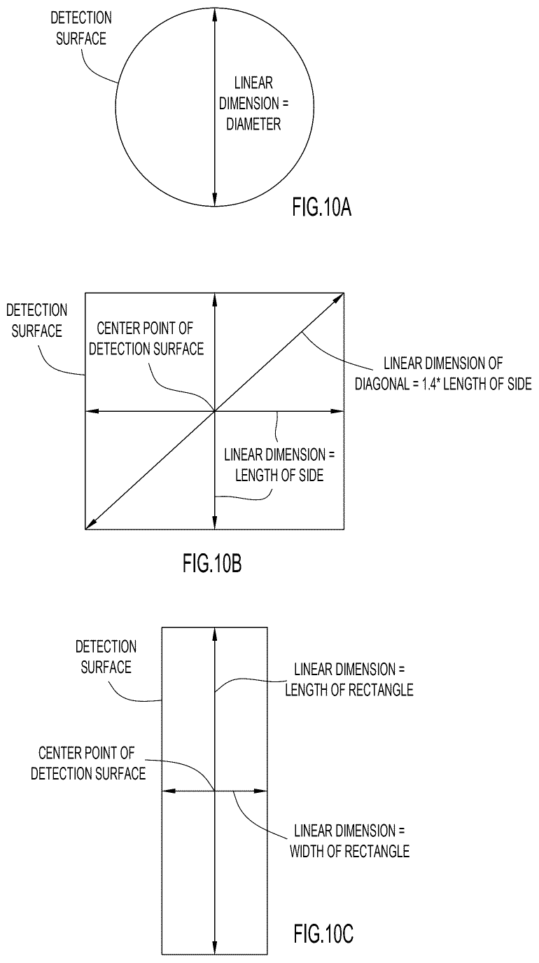

The optical detector 912 has a detection surface oriented substantially normal to the propagation direction of the incident light to be detected. The optical detector 912 can be a high-speed, high-sensitivity photodetector or array of photodetectors made of, for example, indium gallium arsenide. To enable detection of optical signals over the full field of view of the optical receiver, the size and shape of the detection surface of optical detector 912 can be selected to be substantially the same as, i.e., correspond to, the size and shape of the transverse cross section of the optical fiber core. FIGS. 10A-10C illustrate detection surface of the optical detector having different shapes. In general, the detection surface of optical detector 912 has a linear dimension along at least one direction or side of the detection surface. As used herein and in the claims, the linear dimension of the detection surface of the optical detector means the length of a line segment passing through the center point of the detection surface and terminating at opposite edges of the detection surface. For example, as shown in FIG. 10A, if the detection surface of optical detector 912 is circular, the linear dimension of the detection surface is its diameter. According to one non-limiting example, the optical fiber core can have a circular transverse cross section with a diameter in the range of 60 to 200 μm, and the optical detector 912 can have a corresponding circular shape with its linear dimension (diameter) substantially the same as the diameter of the optical fiber core.

If the detection surface of optical detector 912 is non-circular, the length of the linear dimension will vary as a function of the angle of the linear dimension relative to the center point of the detection surface in the plane of the detection surface, i.e., corresponding to different angles within the FOV of the optical receiver. For example, as shown in FIG. 10B, if the detection surface of optical detector 912 is square with horizontally and vertically oriented sides, the linear dimension in the horizontal and vertical directions is the length of a side of the square. At angles oblique to horizontal or vertical, the linear dimension is longer (e.g., along the diagonal, the linear dimension of the detection surface is the length of the side times \sqrt{2}. For a rectangularly shaped detection surface of the optical detector 912, as shown in FIG. 10C, the linear dimension of the detection surface of the optical detector is the length of the detection surface in the direction the length extends and is the width of the detection surface in the direction the width extends. In general, the detection surface of the optical detector 912 can have any desired shape and, other than a circular shape, the linear dimension of the detection surface is a function of the angular orientation of the linear dimension relative to the center point of the detection surface.

Replacing the pinhole architecture with an optical fiber simplifies the spatial filter by eliminating the additional optics necessary to deliver the light to the optical detector and replacing them with a single optical fiber. This optical fiber is permanently aligned to the optical detector, eliminating the trouble of aligning the two conventional lenses downstream of the pinhole with the optical detector and keeping them aligned over time in the presence of temperature variations, vibration, and shock.

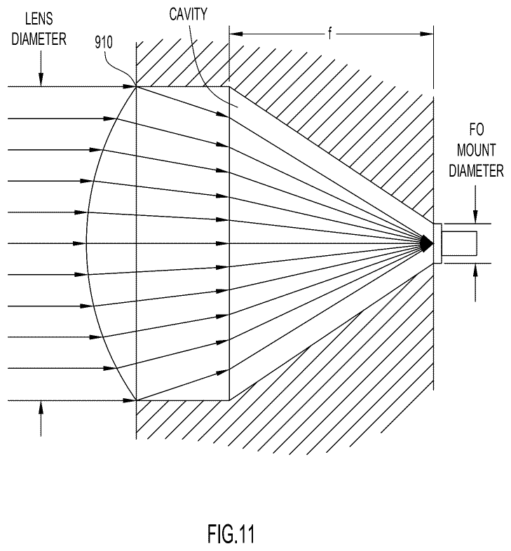

FIG. 11 shows a fiber optic mount 916 of optical fiber 914 taking the place of a pinhole at the focal point of detector lens 910. Detector lens 910 acts as a limiting aperture for the scattered light and the return signal in this example. All of the return signal that passes through detector lens 910 is sent into the fiber core of optical fiber 914 and propagates to the optical detector 912. There is typically more scattered light in the cavity than just the return signal. The scattered light is distributed almost uniformly in the cavity behind the detector lens 910. The surface area of the fiber core of optical fiber 914 is very small compared to the surface area of the cavity. A ratio of these two areas can be used to approximate the amount of scattered light that falls on the fiber core of optical fiber 914. Out of this light, only the rays that are within the acceptance cone of the fiber will propagate to the detector. These two factors work to greatly attenuate scattered light propagating down the fiber core and illuminating the detector element.

Components of the optical receiver, including detector lens 910, optical fiber 914, and optical detector 912 are mounted on an X-Y-Z stage to ensure alignment with the return signal. Typically, this arrangement is attached to a Printed Circuit Board (PCB) in order to maximize temporal response. This detector stage must carry everything and hold it all in alignment while experiencing shock, vibration, and temperature extremes. The difficulty of this task is reduced by using a fiber-based spatial filter. The fiber holder X-Y-Z stage carries very little weight and can be designed to be small, rigid, and effective and also reduces the overall size and weight of the LRF. Once the optical fiber is aligned to the detector lens, no other optics need to be aligned and held in place, unlike the optics following the pinhole in a standard spatial filter. When using a fiber-coupled receiver, the optical detector can be located in a convenient place rather than residing inside the LRF head, making the LRF volume smaller and lighter.

The out-going LRF transmitter beam is designed to have a particular spot diameter at a particular target range. This can be envisioned as the transmitter FOV. The receiver also has a FOV, which must be appropriately sized to compliment the transmitter FOV. The receiver FOV of LRF 90 is a function of the size of the optical detector 912 and the focal length of the detector lens 910. Specifically, in radians, the half-angle FOV for the optical receiver at a given angle within the FOV is defined as the linear dimension of the detection surface of the optical detector 912 at the given angle divided by two times the focal length of the detector lens 910. Note that the half-angle FOV is relevant because the acceptance angle defined in equation (3) above is also represented as a half-angle, and the two half-angles are interrelated in the design of the spatial filter.

$$half angle F O V = \frac{Detector Linear Dimension}{2 * Lens Focal Length} \qquad ( 4 )$$

Once the focal length of the LRF optical receiver lens is determined and the receiver FOV is defined, the fiber core diameter is designated, and the acceptance angle of the fiber is designed to match the receiver FOV using Equation (3). More specifically, selecting the dimensions of the detection surface of the optical detector and the focal length of the detector lens defines the optical receiver's innate FOV. To implement a spatial filter in the optical receiver with an optical fiber, the cross-sectional shape and size of the optical fiber core can be selected to match to the shape and size of the detection surface of the optical detector. “Matching” requires two criteria to be fulfilled. First, the cone of light entering the optical fiber is preserved to an acceptable tolerance once it exits the opposite end of the optical fiber. Second, the slope of the leading edge of the laser pulse is retained to an acceptable tolerance at the output of the optical fiber. As used herein, the terms “match” and “matching” mean that the acceptance angle of the optical fiber, given by equation (4), differs from the receiver FOV, given by equation (3) by no more than 10%. For higher precision applications, the acceptance angle of the optical fiber may differ from the receiver FOV by no more than 5%. For very high precision applications, the acceptance angle of the optical fiber may differ from the receiver FOV by no more than 1%. An acceptable tolerance for the variation in the focal length achievable by inexpensive lenses is ±5%. For more expensive lenses used in higher precision systems, an acceptable tolerance for the variation in the focal length is ±1%.

The length of the optical fiber must be considered when attempting to fulfill both these criteria. When implementing a spatial filter with an optical fiber, the length of the optical fiber is constrained between a practical minimum length and a practical maximum length by operational considerations. That is, the optical fiber must be longer than some minimum length but, in the case of a multimode fiber, shorter than some maximum length. The optical fiber must be longer than the minimum length in order to maximize the spatial filtering and modal discrimination. Whether a single mode fiber or a multimode fiber is used, the minimum length necessary to discriminate against unwanted propagation modes and to eliminate all higher-order modes is on the order of 1 to 2 meters.

For a multimode optical fiber, particularly if a stepped index optical fiber is used, the fiber length may become an issue beyond a certain length because, if the length of the optical fiber is too long, the leading edge of the laser pulse will degrade before reaching the optical detector. The term “dispersion” describes how a pulse of light widens as it propagates through an optical fiber. Material dispersion is caused by the change of the index of refraction of the fiber core versus wavelength. This type of dispersion is small compared to multimode dispersion in a stepped index multimode optical fiber. While the disclosed spatial filter can be implemented with a single mode fiber, a stepped index or graded index multimode optical fiber may be more suitable for certain applications. Calculating the multimode dispersion in a stepped index fiber can be complex and takes into consideration several variables, including the pulse wavelength, how the pulse is injected into the fiber, and how the fiber is coiled. Some typical data transmission speeds versus lengths for multimode fibers are given as follows: 100 Mbit/s up to 2 km (100BASE-FX), 1 Gbit/s up to 1 km, and 10 Gbit/s up to 550 m. The laser pulse widths used in LRFs are on the order of 20 nsec wide FWHM (Full Width Half Max.) The frequency content of one of these pulses is on the order of 50 MHz. Consequently, a multimode optical fiber can carry such pulses approximately 2 km without significantly widening the pulse. According to a non-limiting example, the optical detector may be disposed within the same housing as the other components of the optical receiver, thereby requiring the length of the fiber to be only a few meters, e.g., 2 to 10 meters, well within the maximum length achievable with either a single mode optical fiber or a multimode optical fiber.

Further, the indices of refraction of the core and cladding of the optical fiber can be selected to yield an acceptance angle that is well matched to the optical receiver's FOV to enable return signals within the FOV to be detected while filtering out incident light reaching the optical fiber at angles outside the receiver FOV. As indicated by equation (4), the receiver FOV is a function of the focal length of the detector lens, which can be implemented with one or a plurality of receiver lenses. By manipulating the detector lens (which can be one lens or a set of lenses), the receiver FOV can be adjusted, which is another variable available to match the receiver FOV with the acceptance angle of the optical fiber to achieve optimal spatial filtering.

An optical fiber core having a round transverse cross section corresponds to a receiver field of view whose angular extent is uniform at all angles, in effect a circular cone. The FOV of the optical receiver can be controlled to have any of a wide variety of shapes by using a detection surface having different shapes and optical fibers having corresponding transverse cross sectional shapes. For example, a detection surface of the optical detector complimented by an optical fiber core having a square cross section produces a spatially filtered, square-shaped FOV. With an optical detector having a rectangular detection surface, an optical fiber whose core has a rectangular cross sectional shape can produce a spatially filtered receiver FOV having a wide vertical (elevation) extent and a narrow horizontal (azimuth) extent or vice versa. Such an FOV is beneficial in an LRF designed to observe or track a moving object having vertical trajectory by matching the expected trajectory and allowing simplification of pointing mechanisms within the system. Any of a variety of regular and irregular shapes can be employed as the cross sectional shape of the core of the optical fiber and the detection surface to control the shape of the receiver FOV. According to one option, the optical fiber can be designed as photonic crystal fiber, which can have a non-uniform shape, providing the freedom to design a field of view with virtually any shape. To match the desired aspect ratio, the shape and size of the detection surface of the optical detector is designed to correspond to the cross sectional shape and size of the core of the optical fiber. Though non-circular optical fiber cross sections may result in losses in the fiber, these losses are tolerable due to the relatively short length of the fiber, e.g., less than 10 meters in some implementations.

To enhance spatial filtering, the optical fiber of the system described herein can be a polarization-maintaining fiber, which allows filtering by polarization characteristics of reflected light signals. This capability can enhance spatial filtering by considering the polarization of the return light signal. When incident light impinges on the surface of an object, polarization may be scattered or maintained. Reflections off of metal surfaces tend to maintain polarization better than non-metal objects. Consequently, a polarization-maintaining optical fiber allows greater discrimination between metal objects and non-metal background objects.

Bandpass filtering can be incorporated into the optical receiver by writing a grating into the optical fiber to discriminate by wavelength, e.g., a grating can be designed so that only light within a certain band of frequencies propagates through the optical fiber. This implementation of a bandpass filter eliminates the need for additional discrete optical components for that purpose.

Using a fiber-coupled optical detector also allows fiber optic modulators to be placed in-line with the optical detector to modify the light signal before reaching the detector element. This arrangement allows real-time signal processing at frequencies spanning from near DC up to several gigahertz.

While the fiber-based spatial filter and the optical receiver implemented with a fiber-based spatial filter have been described in the context of a Laser Range Finder (LRF), it will be appreciated that the described fiber-based spatial filter is not limited to applications in an LRF. The described fiber-based spatial filter provides beneficial filtering in any of a wide variety of imaging systems that employ electromagnetic signals capable of propagating in an optical fiber, including medical imaging systems.

In some aspects, the techniques described herein relate to an optical receiver comprising: an optical detector including a detection surface having a linear dimension; and a spatial filter comprising a detector lens to focus a collimated optical signal at a focal point located at a focal length from the detector lens, wherein a field of view of the optical detector is a function of the linear dimension of the detection surface and the focal length of the detector lens, and an optical fiber having a first end mounted at the focal point of the detector lens to receive the optical signal, and a second end coupled to the optical detector, the optical fiber propagating only light received at incident angles no greater than an acceptance angle, wherein the acceptance angle is sized relative to the field of view to spatially filter incident light outside the field of view.

In some aspects, the techniques described herein relate to an optical receiver, wherein the optical fiber comprises a core having a first index of refraction surrounded by a cladding having a second index of refraction, the acceptance angle being a function of the first and second indices of refraction.

In some aspects, the techniques described herein relate to an optical receiver, wherein a cross-sectional shape and size of the core of the optical fiber correspond to a shape and size of the detection surface of the optical detector.

In some aspects, the techniques described herein relate to an optical receiver, wherein the optical fiber is a multimode fiber.

In some aspects, the techniques described herein relate to an optical receiver, wherein the optical fiber is a single-mode fiber.

In some aspects, the techniques described herein relate to an optical receiver, wherein the optical fiber is a polarization-maintaining optical fiber.

In some aspects, the techniques described herein relate to an optical receiver, wherein the acceptance angle of the optical fiber matches the field of view of the optical detector.

In some aspects, the techniques described herein relate to an optical receiver, wherein the detection surface of the optical detector is circular and the linear dimension is the diameter of the detection surface.

In some aspects, the techniques described herein relate to an optical receiver, wherein the detection surface of the optical detector is non-circular, and the linear dimension varies as a function of an angle of the linear dimension relative to a center point of the detection surface.

In some aspects, the techniques described herein relate to a coaxial laser range finder comprising: a telescope to launch a laser signal and to collect a return signal of the laser signal reflected from an object; an optical receiver comprising an optical detector including a detection surface having a linear dimension, and a spatial filter comprising a detector lens to focus the return signal at a focal point located at a focal length from the detector lens, wherein a field of view of the optical detector is a function of the linear dimension of the detection surface and the focal length of the detector lens, and an optical fiber having a first end mounted at the focal point of the detector lens to receive the optical signal, and a second end coupled to the optical detector, the optical fiber propagating only light received at incident angles no greater than an acceptance angle, wherein the acceptance angle is sized relative to the field of view to spatially filter incident light outside the field of view; and optical elements to direct the return signal to the optical receiver.

In some aspects, the techniques described herein relate to an imaging system comprising: an optical receiver comprising an optical detector including a detection surface having a linear dimension, and a spatial filter comprising a detector lens to focus the return signal at a focal point located at a focal length from the detector lens, wherein a field of view of the optical detector is a function of the linear dimension of the detection surface and the focal length of the detector lens, and an optical fiber having a first end mounted at the focal point of the detector lens to receive the optical signal, and a second end coupled to the optical detector, the optical fiber propagating only light received at incident angles no greater than an acceptance angle, wherein the acceptance angle is sized relative to the field of view to spatially filter incident light outside the field of view; and optical elements to optical signal to the detector lens.

In some aspects, the techniques described herein relate to a coaxial laser range finder comprising: a telescope to launch a laser signal and to collect a return signal of the laser signal reflected from an object; an optical detector to detect the return signal; and a spatial filter comprising a detector lens to focus the return signal at a focal point located at a focal length from the detector lens, wherein a receive field of view of the laser range finder is a function of a size of the optical detector and the focal length of the detector lens, and an optical fiber having a first end mounted at the focal point of the detector lens to receive the return signal, and a second end coupled to the optical detector, the optical fiber propagating only light received at incident angles no greater than an acceptance angle, wherein the acceptance angle is sized relative to the receive field of view to spatially filter incident light outside the receive field of view.

In some aspects, the techniques described herein relate to a coaxial laser range finder, wherein the optical detector includes a detection surface having a linear dimension, and the receive field of view is a function of the linear dimension of the detection surface.

In some aspects, the techniques described herein relate to a coaxial laser range finder, wherein the optical fiber comprises a core having a first index of refraction surrounded by a cladding having a second index of refraction, the acceptance angle being a function of the first and second indices of refraction.

In some aspects, the techniques described herein relate to a coaxial laser range finder, wherein a cross-sectional shape and size of the core of the optical fiber correspond to a shape and size of the detection surface of the optical detector.

In some aspects, the techniques described herein relate to a coaxial laser range finder, wherein the telescope is a collimating telescope that up-collimates the laser signal and down-collimates the return signal such that the return signal incident on the detector lens is collimated.

In some aspects, the techniques described herein relate to a coaxial laser range finder, wherein the acceptance angle of the optical fiber matches the receive field of view.

In some aspects, the techniques described herein relate to a fiber-based spatial filter, comprising: a detector lens to focus a collimated optical signal at a focal point located at a focal length from the detector lens; and an optical fiber having a first end mounted at the focal point of the detector lens to receive the optical signal, and a second end coupled to an optical detector, the optical fiber propagating only light received at incident angles no greater than an acceptance angle, wherein the acceptance angle of the optical fiber is sized to spatially filter incident light outside a field of view of the optical detector.

In some aspects, the techniques described herein relate to a fiber-based spatial filter, wherein the field of view is a function of a size and shape of the optical detector and a focal length of the detector lens.

In some aspects, the techniques described herein relate to a fiber-based spatial filter, wherein the optical fiber comprises a core having a first index of refraction surrounded by a cladding having a second index of refraction, the acceptance angle being a function of the first and second indices of refraction, and wherein the acceptance angle of the optical fiber matches the field of view.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. An optical receiver, comprising:
an optical detector including a detection surface having a linear dimension; and
a spatial filter comprising:
a detector lens to focus a collimated optical signal at a focal point located at a focal length from the detector lens, wherein a field of view of the optical detector is a function of the linear dimension of the detection surface and the focal length of the detector lens; and
an optical fiber having a first end mounted at the focal point of the detector lens to receive the optical signal, and a second end coupled to the optical detector, the optical fiber propagating only light received at incident angles no greater than an acceptance angle, wherein the acceptance angle is sized relative to the field of view to spatially filter incident light outside the field of view.

2. The optical receiver of claim 1, wherein the optical fiber comprises a core having a first index of refraction surrounded by a cladding having a second index of refraction, the acceptance angle being a function of the first and second indices of refraction.

3. The optical receiver of claim 2, wherein a cross-sectional shape and size of the core of the optical fiber correspond to a shape and size of the detection surface of the optical detector.

4. The optical receiver of claim 1, wherein the optical fiber is a multimode fiber.

5. The optical receiver of claim 1, wherein the optical fiber is a single-mode fiber.

6. The optical receiver of claim 1, wherein the optical fiber is a polarization-maintaining optical fiber.

7. The optical receiver of claim 1, wherein the acceptance angle of the optical fiber matches the field of view of the optical detector.

8. The optical receiver of claim 1, wherein the detection surface of the optical detector is circular and the linear dimension is the diameter of the detection surface.

9. The optical receiver of claim 1, wherein the detection surface of the optical detector is non-circular, and the linear dimension varies as a function of an angle of the linear dimension relative to a center point of the detection surface.

10. A coaxial laser range finder, comprising:
the optical receiver of claim 1;
a telescope to launch a laser signal and to collect a return signal of the laser signal reflected from an object; and
optical elements to direct the return signal to the detector lens.

11. An imaging system, comprising:
The optical receiver of claim 1; and
optical elements to direct the optical signal to the detector lens.

12. A laser range finder, comprising:
a telescope to launch a laser signal and to collect a return signal of the laser signal reflected from an object;
an optical detector to detect the return signal; and
a spatial filter comprising:
a detector lens to focus the return signal at a focal point located at a focal length from the detector lens, wherein a receive field of view of the laser range finder is a function of a size of the optical detector and the focal length of the detector lens; and
an optical fiber having a first end mounted at the focal point of the detector lens to receive the return signal, and a second end coupled to the optical detector, the optical fiber propagating only light received at incident angles no greater than an acceptance angle, wherein the acceptance angle is sized relative to the receive field of view to spatially filter incident light outside the receive field of view.

13. The laser range finder of claim 12, wherein the optical detector includes a detection surface having a linear dimension, and the receive field of view is a function of the linear dimension of the detection surface.

14. The laser range finder of claim 13, wherein the optical fiber comprises a core having a first index of refraction surrounded by a cladding having a second index of refraction, the acceptance angle being a function of the first and second indices of refraction.

15. The laser range finder of claim 14, wherein a cross-sectional shape and size of the core of the optical fiber correspond to a shape and size of the detection surface of the optical detector.

16. The laser range finder of claim 12, wherein the telescope is a collimating telescope that up-collimates the laser signal and down-collimates the return signal such that the return signal incident on the detector lens is collimated.

17. The laser range finder of claim 12, wherein the acceptance angle of the optical fiber matches the receive field of view.

18. A fiber-based spatial filter, comprising:
a detector lens to focus a collimated optical signal at a focal point located at a focal length from the detector lens; and
an optical fiber having a first end mounted at the focal point of the detector lens to receive the optical signal, and a second end coupled to an optical detector, the optical fiber propagating only light received at incident angles no greater than an acceptance angle,
wherein the acceptance angle of the optical fiber is sized to spatially filter incident light outside a field of view of the optical detector.

19. The fiber-based spatial filter of claim 18, wherein the field of view is a function of a size and shape of the optical detector and a focal length of the detector lens.

20. The fiber-based spatial filter of claim 18, wherein the optical fiber comprises a core having a first index of refraction surrounded by a cladding having a second index of refraction, the acceptance angle being a function of the first and second indices of refraction, and wherein the acceptance angle of the optical fiber matches the field of view.
